(19) United States
(12) Patent Application Publication
(10) Pub. No.: US 2026/0187012 A1
(43) Pub. Date: Jul. 2, 2026

(54) METHODS FOR PERFORMANCE-OPTIMAL TUNNELING OF PCIE UIO/FLIT-MODE PACKETS

(71) Applicant: Intel Corporation, Santa Clara, CA (US)

(72) Inventors: Filip SCHMOLE, Portland, OR (US); Vinit Mathew ABRAHAM, Hillsboro, OR (US); Robert G. BLANKENSHIP, Tacoma, WA (US); Sridhar MUTHRASANALLUR, Bangalore (IN)

(73) Assignee: Intel Corporation, Santa Clara, CA (US)

(21) Appl. No.: 19/004,304

(22) Filed: Dec. 28, 2024

(51) Int. Cl. G06F 13/42

(52) U.S. Cl. CPC G06F 13/4221; G06F 2213/0026

(57) ABSTRACT

A processor, method and system to implement performance-optimal tunneling of PCIe UIO/flit-mode packets. A logic circuit receives a packet for transfer to a peer destination on a packet transfer fabric and evaluates the packet based on a number of criteria related to packet configuration. When the packet meets requirements of the number of criteria related to the packet configuration, the logic circuit encodes a packet header into an unencapsulated format and places payload data of the packet at a beginning of a payload data section of the packet to send the packet to the peer destination. When the packet does not meet the requirements, the logic circuit encodes the packet header into an encapsulated format and places the encapsulated packet header at the beginning of the payload data section of the packet to send the packet to the peer destination.

### BACKGROUND

Computer hardware components such as Central Processing Units (CPUs) typically provide multiple Peripheral Component Interconnect express (PCIe) ports and support the ability to transfer PCIe packets between these ports, a feature known as PCIe peer-to-peer. Existing methods for transferring peer-to-peer PCIe packets utilize a generic multipurpose fabric providing separate parallel header and data buses and rely on a fixed mapping between the PCIe header bits and the fabric's header bus. However, PCIe Generation 6 (Gen6), such as PCIe 6.1, defines new packet formats known as “flit-mode” containing significantly more header bits than in prior generations, making it impractical to do a straight mapping of header bits from one interface to another. “FLIT” stands for FLow control unIT,” of fixed-size data units used for the data transfer. Unordered Input/Output (UIO) requires use of flit-mode packets.

Previous solutions relied on mapping the PCIe header bits to available bits in the generic multipurpose fabric's header bus. For example, mapping the “Address” field to the address bus and the “Type” field to the opcode bus. The disadvantage of this approach is that there are insufficient bits on the fabric's header bus for PCIe Gen6 requirements and it is cost-prohibitive to increase the number of bits on the fabric's header bus to meet PCIe Gen6 UIO/flit-mode requirements. The increased header size in PCIe Gen6 UIO/flit-mode significantly exacerbates this problem and could affect the integrity of the PCIe header with current fabric's header bus.

### BRIEF DESCRIPTION OF DRAWINGS

Various examples in accordance with the present disclosure will be described with reference to the drawings, in which:

FIG. 1 illustrates a system having a source block for sending a packet to a destination block via an internal fabric according to some examples of the disclosure.

FIG. 2 illustrates components of an I/O processor shown in FIG. 1 according to some examples of the disclosure.

FIG. 3 shows a flow chart illustrating a method of operation for sending a packet according to some examples of the disclosure.

FIGS. 4(A)-4(B) show a flow chart illustrating a method of evaluating a packet for transfer to a PCIe peer via a PCIe fabric according to some examples of the disclosure.

FIG. 5 illustrates an example of an unencapsulated PCIe packet for requests and completions on a PCIe fabric according to some examples of the disclosure.

FIG. 6 illustrates an example of an encapsulated PCIe packet for requests and completions on a PCIe fabric according to some examples of the disclosure.

FIG. 7 illustrates an example performance comparison chart for unidirectional read or write on a PCIe fabric for unencapsulated and encapsulated PCIe packets of varying size according to some examples of the disclosure.

FIG. 8 illustrates an example performance comparison chart for bidirectional read or write on a PCIe fabric for unencapsulated and encapsulated PCIe packets of varying size according to some examples of the disclosure.

FIG. 9 illustrates an example computing system.

FIG. 10 illustrates a block diagram of an example processor and/or System on a Chip (SoC) that may have one or more cores and an integrated memory controller.

FIG. 11 is a block diagram illustrating a computing system 1100 configured to implement one or more aspects of the examples described herein.

FIG. 12(A) is a block diagram illustrating both an example in-order pipeline and an example register renaming, out-of-order issue/execution pipeline according to examples.

FIG. 12(B) is a block diagram illustrating both an example in-order architecture core and an example register renaming, out-of-order issue/execution architecture core to be included in a processor according to examples.

FIG. 13 illustrates example of an execution unit(s) circuitry.

FIG. 14 is a block diagram of a register architecture according to some examples.

FIG. 15 illustrates examples of an instruction format.

FIG. 16 illustrates examples of an addressing information field.

### DETAILED DESCRIPTION

The present disclosure relates to methods, apparatus and systems for performance-optimal tunneling of PCIe UIO/flit-mode packets. According to some examples, the disclosure describes a solution to transferring PCIe Gen6 flit-mode and UIO packets without increasing the header size on the generic multipurpose fabric, thereby achieving optimal performance for commonly observed packets while maintaining integrity for the packets. The disclosure describes techniques herein that implement PCIe Gen6 packets. However, the technique can be adapted to other standards and protocols for packet transfer and need not be limited to PCIe or PCIe Gen6. Furthermore, the techniques described herein use an internal fabric as the means for packet transfer. However, the technique is applicable to other links and connections as well, including external transfers, provided the source and destination components communicate using a packet transfer protocol, such as PCIe.

For every PCIe packet that is to be routed peer-to-peer, the techniques of the disclosure perform a test on the PCIe header that determines if it can be encoded on the fabric's header bus. If it can, then a direct-mapped (referred to in the disclosure as unencapsulated, unencapsulated format, or non-tunneled) approach is employed. If it cannot, then a tunnelling (referred to in the disclosure as tunneled, encapsulated, or encapsulated format) approach is employed. In the encapsulation approach, a technique can extract the routing and Quality-of-Service (QoS) related information from the header and place those values on the fabric's header bus, while placing the PCIe header at the beginning of the payload data. A header evaluation (e.g., test) is designed to favor commonly observed PCIe Gen6 UIO packets, such as cacheline-aligned memory requests, as candidates for use of the unencapsulated format, while headers that fail the test use the encapsulated format.

The header test makes it possible to reach maximum peer-to-peer bandwidth for commonly observed PCIe Gen6 UIO packets without costly increases to the number of wires on the fabric, while the fallback method of tunneling by encapsulation ensures complete integrity even when the header test is unsuccessful. In addition, the tunneling method enables support for trailer integrity, enabling true end-to-end link encryption and data Endpoint Cyclic Redundancy Check (ECRC) without increasing the connection lines between peers on a packet transfer fabric.

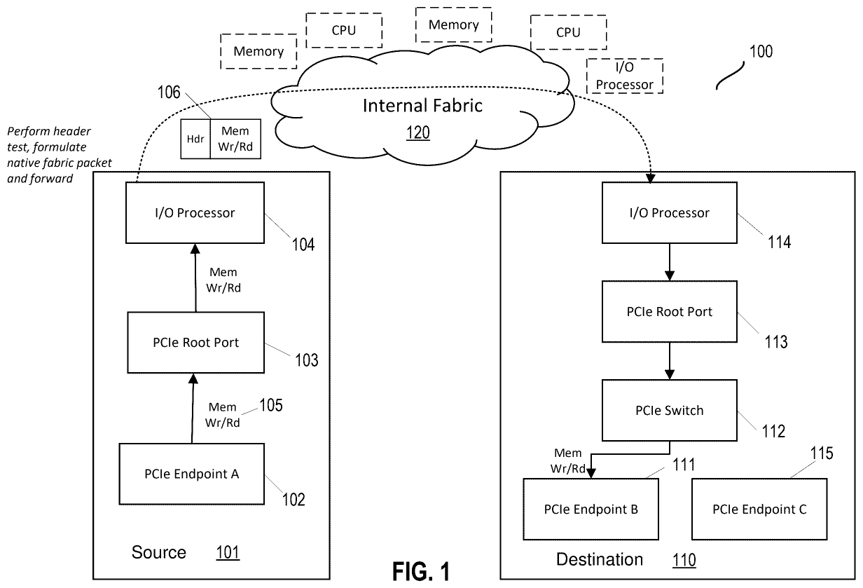

FIG. 1 illustrates a system having a source block for sending a packet to a destination block via an internal fabric according to some examples of the disclosure. FIG. 1 shows a system 100 that includes a source block 101 for sending a packet to a destination block 110, via a data transfer fabric. In the example of FIG. 1, the data transfer fabric is an internal fabric 120 that connects components of a chip, die, package, system on a chip, etc., for packet transfer between the various components. For explanatory purpose, the disclosure describes the operations of the various units based on the PCIe standard, and more specifically, to the PCIe Gen 6 standard or protocol. However, the techniques of the disclosure can be readily adapted for use with other standards or protocols.

Hence, the source block 101 includes a PCIe endpoint (labeled PCIe endpoint A) 102, PCIe root port 103 and an Input/Output (I/O) processor 104. The root port 103 is the entry point for a CPU or a host controller onto the PCIe bus, while the endpoint is a device that connects to the PCIe bus and communicates with the root port. The PCIe endpoint 102 generates a packet, herein shown as a memory write or read operation (memWr/Rd) 105 for writing or reading data to/from a memory location within the destination block 110, and sends it to the I/O processor 104, via PCIe root port 103.

The I/O processor 104 performs operations further described herein to generate an appropriate header and payload (shown as packet 106) for sending to a destination PCIe endpoint 111 (labeled PCIe endpoint B) via the internal fabric 120. Other PCIe peer components are shown (designated by dashed lines) also coupling to the internal fabric for PCIe packet transfer. In the example of FIG. 1, packet 106 is sent to the PCIe endpoint 111.

The destination block 110 also includes a PCIe root port 113 and I/O processor 114, which operate similarly to the PCIe root port 103 and the I/O processor 104, but herein receiving the sent packet from source block 101. The packet 106 is processed by the I/O processor 114 and routed to the designated destination at PCIe endpoint 111 via PCIe root port 113 and PCIe switch 112. The PCIe switch 112 is present to show that the routing of a packet may be switched between/among a number of endpoints (herein shown as a second endpoint “C” 115). Because the components 102-104 of the source block 101 and components 111-114 of the destination block 110 operate in both directions, the destination block 110 could be the sender and the source block 101 could be the recipient of packets as well. For example, for a memory Rd operation, the PCIe endpoint A 102 could send a request packet for a memory read to the PCIe endpoint B 111 and the PCIe endpoint 111 can reply by sending a completion packet with the read data from the memory to PCIe endpoint A 102. Note that the system 100 is shown as an example system for understanding the techniques described in the disclosure. Other systems can be readily employed to practice the techniques of the disclosure.

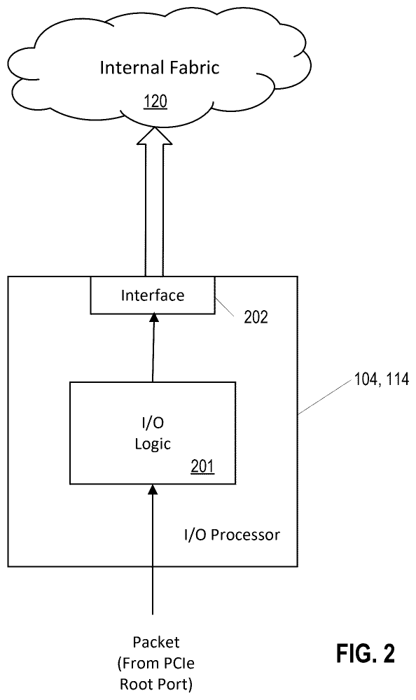

FIG. 2 illustrates components of an I/O processor shown in FIG. 1 according to some examples of the disclosure. The I/O processor can be the I/O processor 104 or I/O processor 114. Furthermore, the processor need not necessarily be an I/O processor. Instead it can be most any type of processor for handing I/O operations. The I/O processor 104, 114 has an I/O logic 201 (e.g., logic circuit 201) and an interface 202, which couples to the internal fabric 120. The I/O logic 201 receives a packet (e.g. from the root port 103) for transfer on to the internal fabric 120. The packet can be a request packet or a completion packet.

In operation the logic circuit 201 receives a packet for transfer to a peer destination on a packet transfer fabric and evaluates the packet based on a number of criteria related to packet configuration, wherein the logic circuit 201 operates as follows:
when the packet meets requirements of the number of criteria related to the packet configuration, the logic circuit 201 encodes a packet header into an unencapsulated format and place payload data of the packet at a beginning of a payload data section of the packet; and
when the packet does not meet the requirements of the number of criteria related to the packet configuration, the logic circuit 201 encodes the packet header into an encapsulated format and places the encapsulated packet header at the beginning of the payload data section of the packet.

For every PCIe packet that is to be routed peer-to-peer, the logic circuit 201 performs a test on the PCIe packet header that determines if it can be encoded unencapsulated on the fabric's header bus. If it can, then a direct-mapped (unencapsulated) approach is employed. If it cannot, then a tunnelling (encapsulated) approach is employed. In the encapsulation approach, in some examples, logic circuit 201 extracts the routing information, and in some cases a Quality-of-Service (QoS) related information, from the packet header and places those values on the fabric's header bus, while placing the PCIe packet header at the beginning of the payload data section. In some instances, an optional PCIe trailer can be placed at the end of the payload data section. The length of the added payload data to accommodate the header depends on the size of the packet header. In some examples, the added header data is rounded to the nearest 16 bytes. The header evaluation (e.g., test) is designed to favor commonly observed PCIe Gen6 UIO packets, such as cacheline-aligned memory requests, as candidates for use in the unencapsulated format, while headers that fail the test use the encapsulated format.

The interface 202 receives the packet from the logic circuit 201 in the unencapsulated format or the encapsulated format and transmits the packet onto the packet transfer fabric to send the packet to the peer destination.

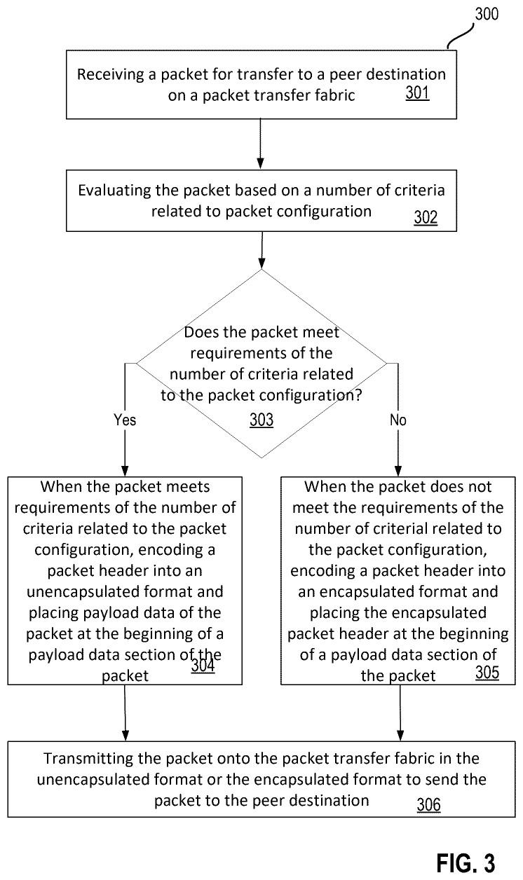

FIG. 3 shows a flow chart illustrating a method of operation for sending a packet according to some examples of the disclosure. FIG. 3 shows a method 300 that can be performed by a processor, such as the I/O processor 104, 114 having the logic circuit 201 and the interface 202. At operation 301, the processor receives a packet for transferring to a peer destination on a packet transfer fabric.

At operation 302, the processor evaluates the packet based on a number of criteria related to packet configuration and makes a decision based on the evaluation at operation 303. When the packet meets requirements of the number of criteria related to the packet configuration, the processor encodes a packet header into an unencapsulated format and places payload data of the packet at a beginning of a payload data section of the packet (as shown in operation 304). When the packet does not meet the requirements of the number of criterial related to the packet configuration, the processor encodes the packet header into an encapsulated format and places the encapsulated packet header at the beginning of the payload data section of the packet (as shown in operation 305).

Once determining whether the packet is to be in the unencapsulated format or in the encapsulated format, the processor transmits, via an interface, the packet onto the packet transfer fabric in the unencapsulated format or the encapsulated format to send the packet to the peer destination at operation 306. The packet can be a request packet or a completion (of the request) packet.

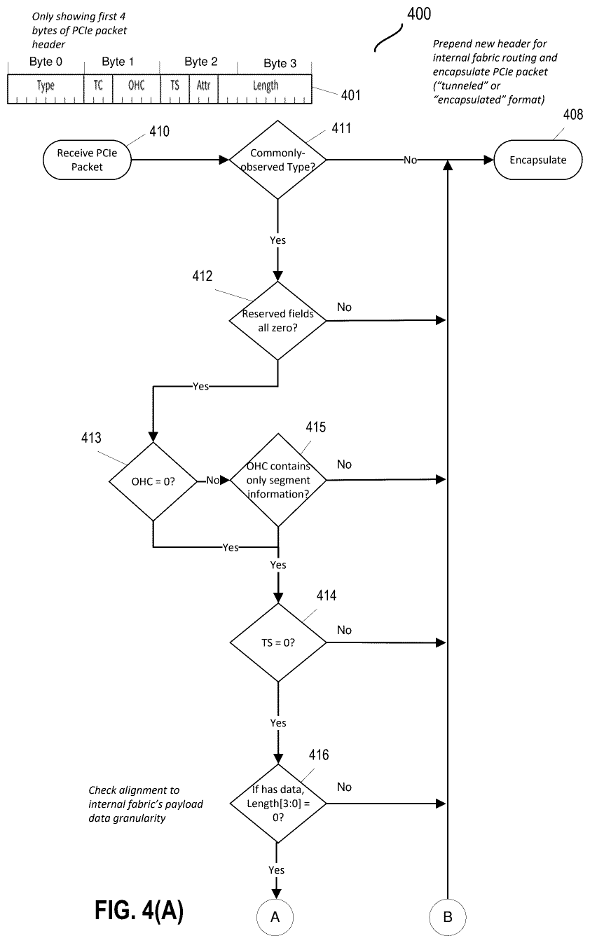

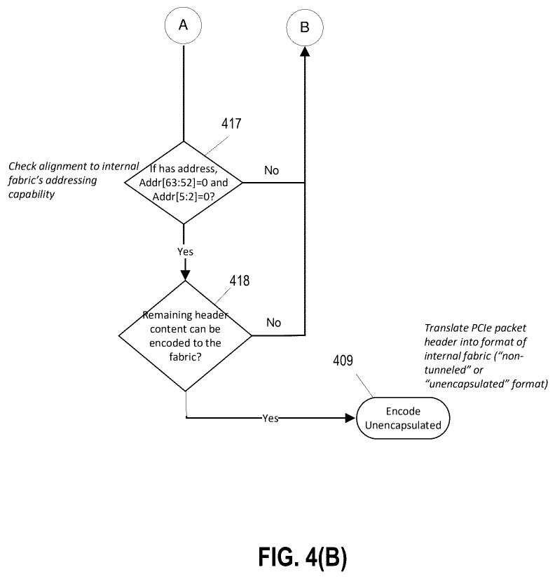

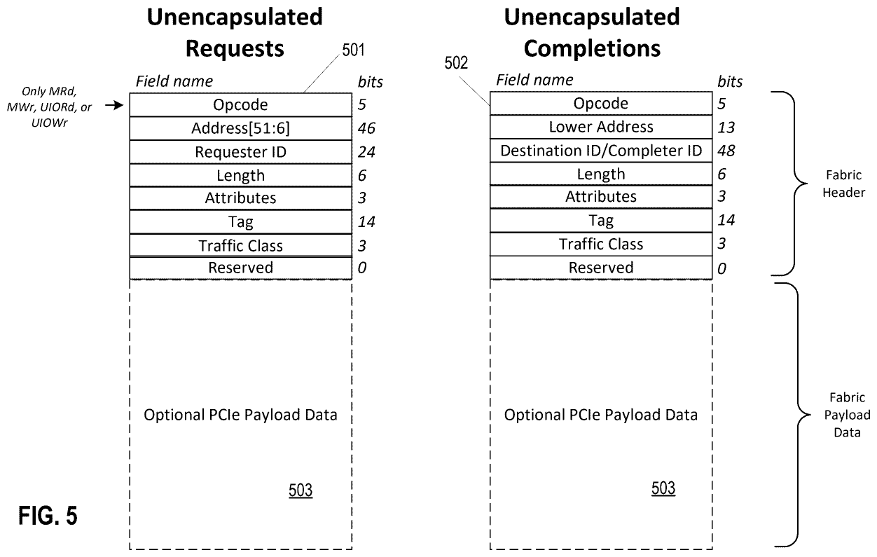

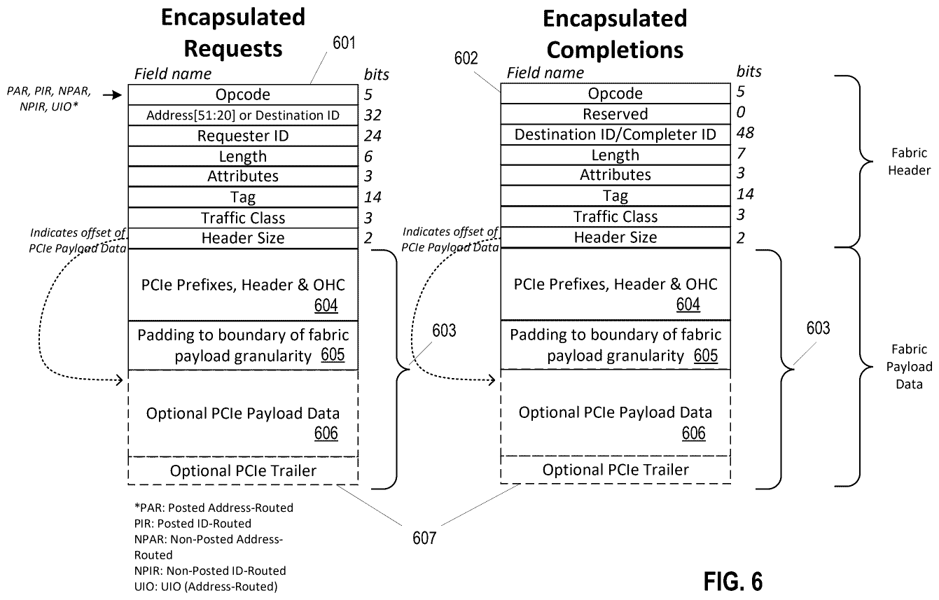

FIGS. 4(A)-4(B) show a flow chart illustrating a method of evaluating a packet for transfer to a PCIe peer via a PCIe fabric according to some examples of the disclosure. Note that FIG. 4(B) is a continuation of FIG. 4(A) where the connections shown by circled letters “A” and “B” indicate the respective connections of the flow chart. Furthermore, FIGS. 4(A) and 4(B) are collectively referred to simply as FIG. 4 in the description below. FIG. 5 illustrates an example of an unencapsulated PCIe packet for requests and completions on a PCIe fabric according to some examples of the disclosure. FIG. 6 illustrates an example of an encapsulated PCIe packet for requests and completions on a PCIe fabric according to some examples of the disclosure. Flow chart 400 of FIG. 4 should be read in reference to the packet formats shown in FIG. 5 and FIG. 6.

FIG. 4 is described in reference to a PCIe peer-to-peer communication and more specifically to PCIe Gen6 packet transfer across a packet transfer fabric, such as an internal fabric of a die, chip, package, etc., and in particular to UIO/flit-mode packets. FIG. 4 also shows first 4 bytes of a PCIe header 401 which the decision blocks of flow diagram 400 looks at for evaluating whether the unencapsulated format or the encapsulated format is to be implemented.

FIG. 5 shows packet formats for an unencapsulated request 501 and an unencapsulated completion 502. The field names indicate the fields that are sent on the header connection of the PCIe fabric, such as the internal fabric 120. The total number of bits of the fields total to less than or equal to the number of header lines available for the PCIe connection on the packet transfer fabric. When the PCIe packet is encoded for unencapsulated transmission, the packet header is encoded into an unencapsulated format and the payload data of the packet is placed at the beginning of the payload section 503 (as noted in operation 304 of FIG. 3).

FIG. 6 shows packet formats for an encapsulated request 601 and an encapsulated completion 602. The field names indicate the fields that are sent on the header connection of the PCIe fabric, such as the internal fabric 120. The total number of bits of the fields total to less than or equal to the number of header lines available for the PCIe connection on the packet transfer fabric, similar to the packet formats 501, 502. However, in order to accommodate the additional size of the PCIe header, when present (such as for some PCIe packets using UIO/flit-mode), the PCIe header is moved to the beginning 604 of the PCIe payload data section 603. The entirety of the PCIe header is moved to the beginning 604 of the payload data section 603 in some examples. In some instances, other information from the packet can be moved here as well. Hence, the PCIe packet header is encapsulated in the data payload. The actual payload data is not placed at the beginning of the payload data section 603. Instead, the PCIe payload data 606 follows the PCIe packet header in the payload data section 603. Padding bits 605 can be added after the packet header to align the actual payload data to the boundary of the fabric payload granularity. The number of bytes of the header moved to the payload data section 603 is noted as Header Size as one of the fields of the Field Name. This Header Size indicates the offset of the actual payload data 606 in the payload data section 603. In some examples, the number of 16-byte chunks of offset is encoded as the 2-bit value (Header Size) for the offset indicator. The example of FIG. 6 shows 2 bits to indicate this offset in the Header Size field. When an optional PCIe trailer is used, the PCIe trailer 607 is placed at the tail end of the payload data section 603.

FIG. 4 shows a flow chart 400 to make the evaluation for unencapsulated or encapsulated format for the PCIe packets. At operation 410 the PCIe packet is received (e.g., such as by I/O logic 201). A decision is made, at operation 411, as to whether the packet is a commonly-observed Type (Byte 0 of PCIe header 401). Commonly observed Types are Memory Read, Memory Write, UIO Read, UIO Write for Requests; or Successful Memory Read or UIO Read Completion, Successful or Unsuccessful UIO Write Completion. If commonly-observed Type, the evaluation progresses for the unencapsulated format (packet format 501 or 502). Otherwise, the packet is encapsulated to packet format 601 or 602 at operation 408. The reserved fields are checked to determine if they are all zeros at operation 412. If all zeros, then the evaluation progresses to operation 413; if not, the packet is encapsulated 408.

At operation 413, the Orthogonal Header Content (OHC) is checked to see if it has a 0 value. If so, then the evaluation progresses. If not the flow moves to check if the OHC contains only segment information at operation 415. If the OHC contains only segment information, then the flow progresses to operation 414; if not, the packet is encapsulated 408. In some examples, operation 415 is not used, such that when OHC is not 0, the packet is encapsulated 408.

At operation 414, the Trailer Size (TS) is checked. If TS is 0, then the evaluation progresses to operation 416; if not, the packet is encapsulated 408. Operation 416 evaluates to check if the alignment fits to the packet transfer fabric's payload data by checking if Length[3: 0] is 0. If so, then the evaluation progresses to operation 417; if not, encapsulate 408. Operation 417 evaluates to check if the alignment fits to the packet transfer fabric's addressing capability by checking Addr[63:52] is 0 and Addr[5:2] is 0. If so, then the evaluation progresses to operation 418; if not, encapsulate 408. At operation 418, the remaining header content of the original packet is checked if the content can be encoded in the unencapsulated format. If so, the original PCIe packet passes the various number of criteria listed in the decision blocks 411-418 to qualify being encoded and sent in the unencapsulated format (at operation 409) on the internal fabric. If not passing any of the evaluation criteria, the encapsulated format 408 is used.

In some examples, other criteria can be added as a requirement for encoding the packet in the unencapsulated format. Such checks can include one or more of:

For a Request that is one of a Memory Read, Memory Write, UIO Read or UIO Write:
Address is aligned to a 64-byte boundary
Length of the request is in integer multiples of 64 bytes
First Byte Enable and Last Byte Enable are 0xF
ID based ordering (IDO) is 0 (only applies to non-UIO requests)
If it is a Memory Write, Tag field is 0
Address Type (AT) field is 0

For a Completion that is one of the following types:
IDO is 0 (only applies to non-UIO read completions)
Byte count Modify (BCM) is 0 (only applies to non-UIO read completions)

Furthermore, the PCIe packet does not have the following:
End-to-end vendor-defined TLP prefixes
Traffic Light Protocol (TLP) suffix/trailer
End-to-End Data Integrity Check (ECRC)
Steering tag
Process Address Space ID (PASID)
Selective Integrity and Data Encryption (IDE) PCIe link encryption

### Performance Overrides

By default, preserving the integrity of the packet is paramount, even if it reduces performance by triggering the use of encapsulation mode excessively. However, opt-in configuration settings make it possible to ignore certain attributes of the packet that would ordinarily trigger encapsulation. This allows a user to favor performance over packet integrity in certain cases, such as the following:
1. Reserved fields are nonzero
2. Trailer present: Header indicates that a trailer is present (TS=1)
3. Process Address Space ID (PASID) is nonzero
4. TLP Processing Hints (TPH): TH, PH, or ST fields are nonzero
5. Link encryption-related fields are nonzero (Stream ID, Sub Stream, K, etc.)

### Performance Optimization for Non-Posted Requests With RSV=1

The PCIe Gen6 specification optionally allows a Requester to specify Requester Segment information in Non-Posted Requests by including the additional header content and setting the Requester Segment Valid (RSV) bit to one. However, including this information results in a loss of link efficiency due to the increased header size and could trigger the use of encapsulation mode by violating one of the criteria. Thus, there can be mitigation in some examples. This scheme is as follows.

Perform a lookup on the address of the Request and determine the Segment Number of the Completer. If the Completer Segment is the same as the Requester Segment, strip the additional header content from the packet to improve link efficiency on the target PCIe link(s) and increase the likelihood of using the more efficient unencapsulated packet format. Provide a configuration mode to enable/disable this functionality.

### Performance Optimization for Non-Posted Requests With RSV=0

The PCIe Gen6 specification allows a Requester to omit Requester Segment information in Non-Posted Requests to improve link efficiency. However, omitting this information could result in a performance penalty because if the Completer is in a different Segment, the Root Complex may take ownership of the Request. A scheme can be implemented that avoids taking ownership and mitigate this issue. The scheme is as follows.

Determine the implied Requester Segment using the captured Segment Number of the PCIe port that initially received the request. Perform a lookup on the address of the Request and determine the Segment Number of the Completer. If the Completer Segment is different than the implied Requester Segment, insert the implied Requester Segment as an explicit Requester Segment into the Request packet and set Requester Segment Valid (RSV) to one.

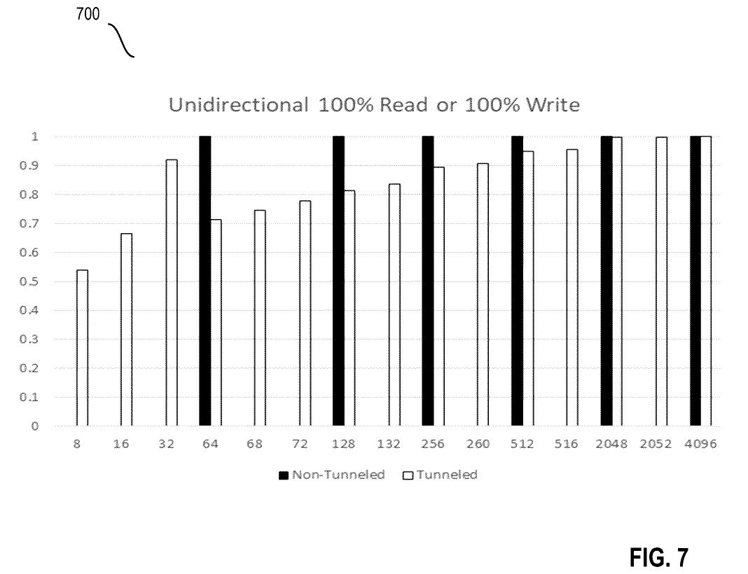

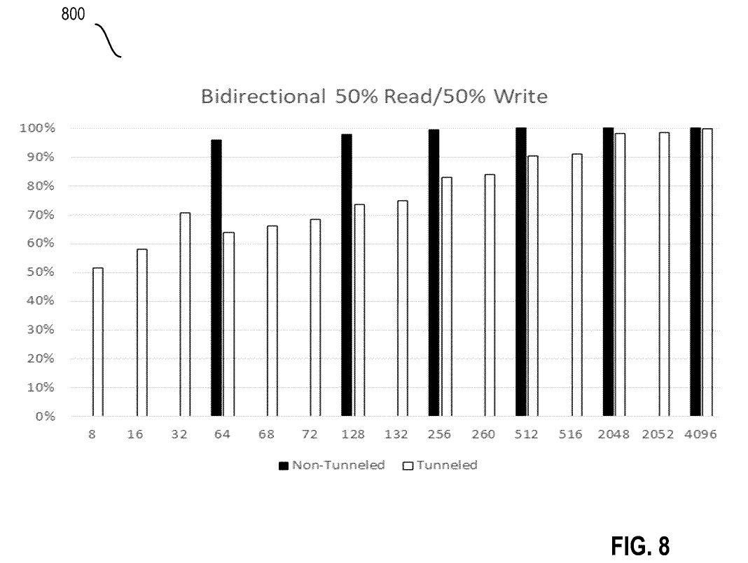

FIG. 7 illustrates an example performance comparison chart 700 for unidirectional read or write on a PCIe fabric for unencapsulated (Non-Tunneled) and encapsulated (Tunneled) PCIe packets of varying size according to some examples of the disclosure. FIG. 8 illustrates an example performance comparison chart 800 for bidirectional read or write on a PCIe fabric for unencapsulated (Non-Tunneled) and encapsulated (Tunneled) PCIe packets of varying size according to some examples of the disclosure.

The y-axis of both charts 700, 800 indicates the percent of achievable PCIe Gen6 bandwidth, assuming the peer-to-peer fabric has a 64-byte wide data bus running at 2 GHz. For packets with a payload length that is an integer multiple of 64 bytes, these charts demonstrate that the non-tunneled format significantly improves bandwidth, approaching 100% of the maximum theoretical PCIe Gen6 bandwidth.

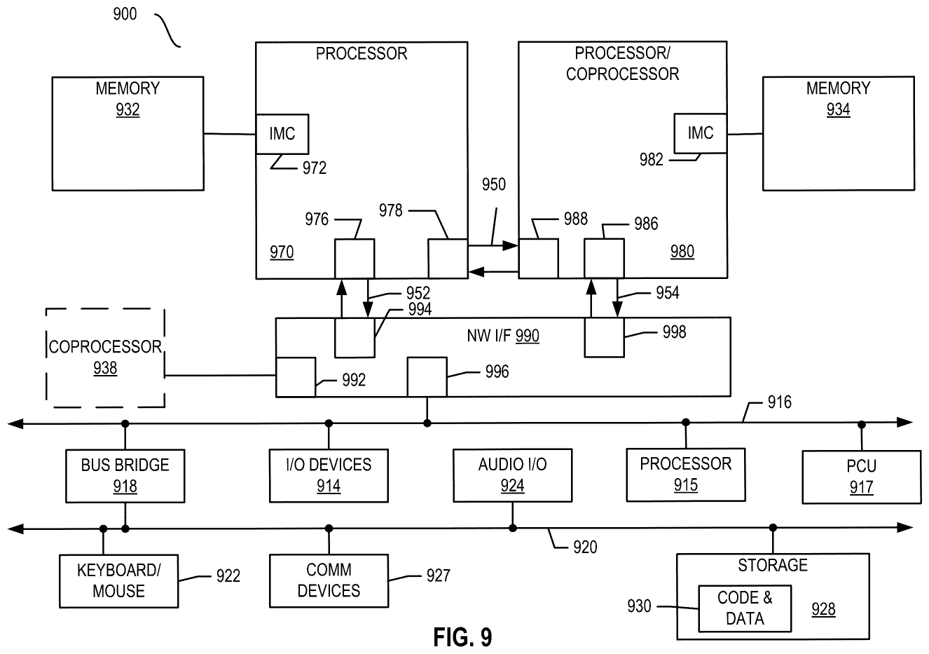

Although the disclosure describes some examples above in way of processors and processing schemes, other techniques can implement the same or equivalent techniques described. In some examples, the described I/O processor can be implemented in a processor architecture described in FIG. 9-FIG. 19.

### Example Systems

FIG. 9 illustrates an example computing system. Multiprocessor system 900 is an interfaced system and includes a plurality of processors or cores including a first processor 970 and a second processor 980 coupled via an interface 950 such as a point-to-point (P-P) interconnect, a fabric, and/or bus. In some examples, the first processor 970 and the second processor 980 are homogeneous. In some examples, first processor 970 and the second processor 980 are heterogenous. Though the example multiprocessor system 900 is shown to have two processors, the system may have three or more processors, or may be a single processor system. In some examples, the computing system is a system on a chip (SoC).

Processors 970 and 980 are shown including integrated memory controller (IMC) circuitry 972 and 982, respectively. Processor 970 also includes interface circuits 976 and 978; similarly, second processor 980 includes interface circuits 986 and 988. Processors 970, 980 may exchange information via the interface 950 using interface circuits 978, 988. IMCs 972 and 982 couple the processors 970, 980 to respective memories, namely a memory 932 and a memory 934, which may be portions of main memory locally attached to the respective processors.

Processors 970, 980 may each exchange information with a network interface (NW I/F) 990 via individual interfaces 952, 954 using interface circuits 976, 994, 986, 998. The network interface 990 (e.g., one or more of an interconnect, bus, and/or fabric, and in some examples is a chipset) may optionally exchange information with a co-processor 938 via an interface circuit 992. In some examples, the co-processor 938 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator, a data streaming accelerator, data graph operations, or the like.

A shared cache (not shown) may be included in either processor 970, 980 or outside of both processors, yet connected with the processors via an interface such as P-P interconnect, such that either or both processors'local cache information may be stored in the shared cache if a processor is placed into a low power mode.

Network interface 990 may be coupled to a first interface 916 via interface circuit 996. In some examples, first interface 916 may be an interface such as a Peripheral Component Interconnect (PCI) interconnect, a PCI Express interconnect or another I/O interconnect. In some examples, first interface 916 is coupled to a power control unit (PCU) 917, which may include circuitry, software, and/or firmware to perform power management operations with regard to the processors 970, 980 and/or co-processor 938. PCU 917 provides control information to a voltage regulator (not shown) to cause the voltage regulator to generate the appropriate regulated voltage. PCU 917 also provides control information to control the operating voltage generated. In various examples, PCU 917 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 917 is illustrated as being present as logic separate from the processor 970 and/or processor 980. In other cases, PCU 917 may execute on a given one or more of cores (not shown) of processor 970 or 980. In some cases, PCU 917 may be implemented as a microcontroller (dedicated or general-purpose) or other control logic configured to execute its own dedicated power management code, sometimes referred to as P-code. In yet other examples, power management operations to be performed by PCU 917 may be implemented externally to a processor, such as by way of a separate power management integrated circuit (PMIC) or another component external to the processor. In yet other examples, power management operations to be performed by PCU 917 may be implemented within BIOS or other system software.

Various I/O devices 914 may be coupled to first interface 916, along with a bus bridge 918 which couples first interface 916 to a second interface 920. In some examples, one or more additional processor(s) 915, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 916. In some examples, second interface 920 may be a low pin count (LPC) interface. Various devices may be coupled to second interface 920 including, for example, a keyboard and/or mouse 922, communication devices 927 and storage circuitry 928. Storage circuitry 928 may be one or more non-transitory machine-readable storage media as described below, such as a disk drive or other mass storage device which may include instructions/code and data 930 and may implement the storage 'ISAB03 in some examples. Further, an audio I/O 924 may be coupled to second interface 920. Note that other architectures than the point-to-point architecture described above are possible. For example, instead of the point-to-point architecture, a system such as multiprocessor system 900 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

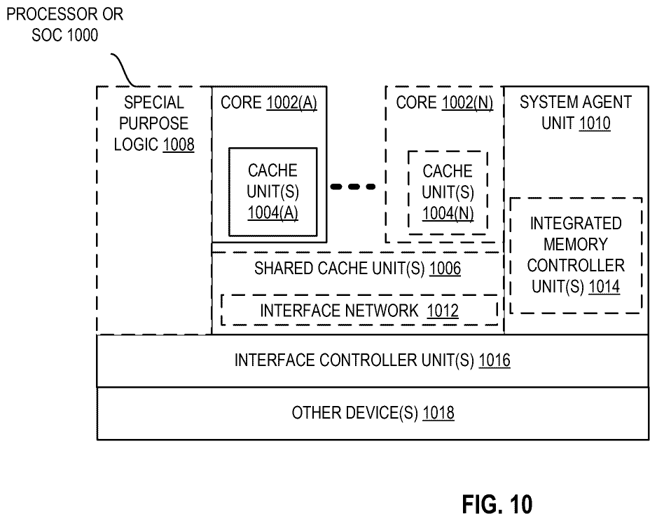

FIG. 10 illustrates a block diagram of an example processor and/or SoC 1000 that may have one or more cores and an integrated memory controller. The solid lined boxes illustrate a processor and/or SoC 1000 with a single core 1002(A), system agent unit circuitry 1010, and a set of one or more interface controller unit(s) circuitry 1016, while the optional addition of the dashed lined boxes illustrates an alternative processor and/or SoC 1000 with multiple cores 1002(A)-(N), a set of one or more integrated memory controller unit(s) circuitry 1014 in the system agent unit circuitry 1010, and special purpose logic 1008, as well as a set of one or more interface controller unit(s) circuitry 1016. Note that the processor and/or SoC 1000 may be one of the processors 970 or 980, or co-processor 938 or 915 of FIG. 9.

Thus, different implementations of the processor and/or SoC 1000 may include: 1) a CPU with the special purpose logic 1008 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like(which may include one or more cores, not shown), and the cores 1002(A)-(N) being one or more general purpose cores (e.g., general purpose in-order cores, general purpose out-of-order cores, or a combination of the two); 2) a co-processor with the cores 1002(A)-(N) being a large number of special purpose cores intended primarily for graphics and/or scientific (throughput); and 3) a co-processor with the cores 1002(A)-(N) being a large number of general purpose in-order cores. Thus, the processor and/or SoC 1000 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 1000 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1004(A)-(N) within the cores 1002(A)-(N), a set of one or more shared cache unit(s) circuitry 1006, and external memory (not shown) coupled to the set of integrated memory controller unit(s) circuitry 1014. The set of one or more shared cache unit(s) circuitry 1006 may include one or more mid-level caches, such as level 2(L2), level 3(L3), level 4(L4), or other levels of cache, such as a last level cache (LLC), and/or combinations thereof. While in some examples interface network circuitry 1012 (e.g., a ring interconnect) interfaces the special purpose logic 1008 (e.g., integrated graphics logic), the set of shared cache unit(s) circuitry 1006, and the system agent unit circuitry 1010, alternative examples use any number of well-known techniques for interfacing such units. In some examples, coherency is maintained between one or more of the shared cache unit(s) circuitry 1006 and cores 1002(A)-(N). In some examples, interface controller unit(s) circuitry 1016 couple the cores 1002(A)-(N) to one or more other devices 1018 such as one or more I/O devices, storage, one or more communication devices (e.g., wireless networking, wired networking, etc.), etc.

In some examples, one or more of the cores 1002(A)-(N) are capable of multi-threading. The system agent unit circuitry 1010 includes those components coordinating and operating cores 1002(A)-(N). The system agent unit circuitry 1010 may include, for example, power control unit (PCU) circuitry and/or display unit circuitry (not shown). The PCU may be or may include logic and components needed for regulating the power state of the cores 1002(A)-(N) and/or the special purpose logic 1008 (e.g., integrated graphics logic). The display unit circuitry is for driving one or more externally connected displays.

The cores 1002(A)-(N) may be homogenous in terms of instruction set architecture (ISA). Alternatively, the cores 1002(A)-(N) may be heterogeneous in terms of ISA; that is, a subset of the cores 1002(A)-(N) may be capable of executing an ISA, while other cores may be capable of executing only a subset of that ISA or another ISA.

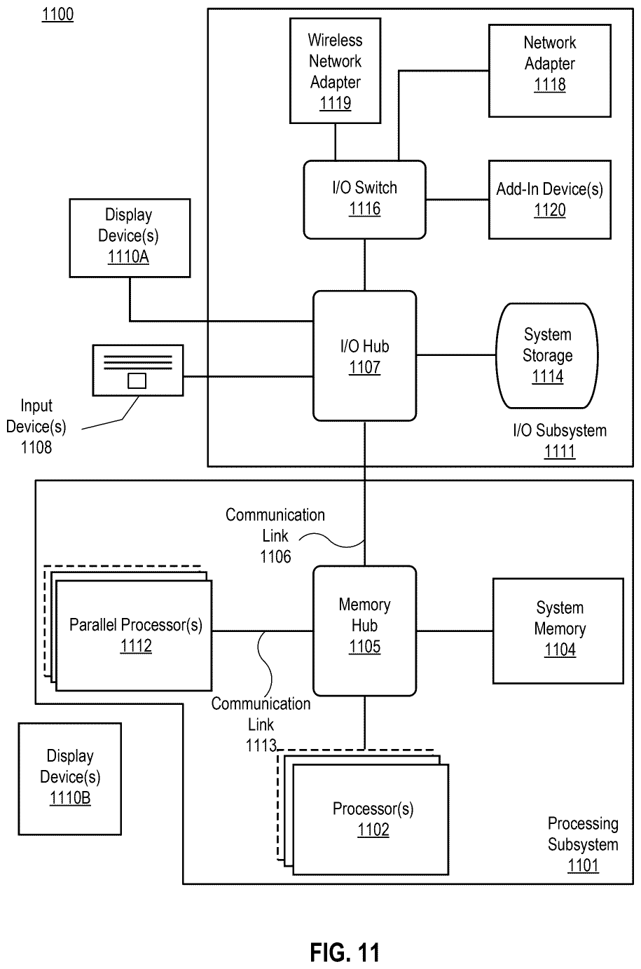

FIG. 11 is a block diagram illustrating a computing system 1100 configured to implement one or more aspects of the examples described herein. The computing system 1100 includes a processing subsystem 1101 having one or more processor(s) 1102 and a system memory 1104 communicating via an interconnection path that may include a memory hub 1105. The memory hub 1105 may be a separate component within a chipset component or may be integrated within the one or more processor(s) 1102. The memory hub 1105 couples with an I/O subsystem 1111 via a communication link 1106. The I/O subsystem 1111 includes an I/O hub 1107 that can enable the computing system 1100 to receive input from one or more input device(s) 1108. Additionally, the I/O hub 1107 can enable a display controller, which may be included in the one or more processor(s) 1102, to provide outputs to one or more display device(s) 1110A. In some examples the one or more display device(s) 1110A coupled with the I/O hub 1107 can include a local, internal, or embedded display device.

The processing subsystem 1101, for example, includes one or more parallel processor(s) 1112 coupled to memory hub 1105 via a bus or communication link 1113. The communication link 1113 may be one of any number of standards-based communication link technologies or protocols, such as, but not limited to PCI Express, or may be a vendor specific communications interface or communications fabric. The one or more parallel processor(s) 1112 may form a computationally focused parallel or vector processing system that can include a large number of processing cores and/or processing clusters, such as a many integrated core (MIC) processor. For example, the one or more parallel processor(s) 1112 form a graphics processing subsystem that can output pixels to one of the one or more display device(s) 1110A coupled via the I/O hub 1107. The one or more parallel processor(s) 1112 can also include a display controller and display interface (not shown) to enable a direct connection to one or more display device(s) 1110B.

Within the I/O subsystem 1111, a system storage unit 1114 can connect to the I/O hub 1107 to provide a storage mechanism for the computing system 1100. An I/O switch 1116 can be used to provide an interface mechanism to enable connections between the I/O hub 1107 and other components, such as a network adapter 1118 and/or wireless network adapter 1119 that may be integrated into the platform, and various other devices that can be added via one or more add-in device(s) 1120. The add-in device(s) 1120 may also include, for example, one or more external graphics processor devices, graphics cards, and/or compute accelerators. The network adapter 1118 can be an Ethernet adapter or another wired network adapter. The wireless network adapter 1119 can include one or more of a Wi-Fi, Bluetooth, near field communication (NFC), or other network device that includes one or more wireless radios.

The computing system 1100 can include other components not explicitly shown, including USB or other port connections, optical storage drives, video capture devices, and the like, which may also be connected to the I/O hub 1107. Communication paths interconnecting the various components in FIG. 11 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 1112 may incorporate circuitry optimized for graphics and video processing, including, for example, video output circuitry, and constitutes a graphics processing unit (GPU). Alternatively or additionally, the one or more parallel processor(s) 1112 can incorporate circuitry optimized for general purpose processing, while preserving the underlying computational architecture, described in greater detail herein. Components of the computing system 1100 may be integrated with one or more other system elements on a single integrated circuit. For example, the one or more parallel processor(s) 1112, memory hub 1105, processor(s) 1102, and I/O hub 1107 can be integrated into a system on chip (SoC) integrated circuit. Alternatively, the components of the computing system 1100 can be integrated into a single package to form a system in package (SIP) configuration. In some examples at least a portion of the components of the computing system 1100 can be integrated into a multi-chip module (MCM), which can be interconnected with other multi-chip modules into a modular computing system.

It will be appreciated that the computing system 1100 shown herein is illustrative and that variations and modifications are possible. The connection topology, including the number and arrangement of bridges, the number of processor(s) 1102, and the number of parallel processor(s) 1112, may be modified as desired. For instance, system memory 1104 can be connected to the processor(s) 1102 directly rather than through a bridge, while other devices communicate with system memory 1104 via the memory hub 1105 and the processor(s) 1102. In other alternative topologies, the parallel processor(s) 1112 are connected to the I/O hub 1107 or directly to one of the one or more processor(s) 1102, rather than to the memory hub 1105. In other examples, the I/O hub 1107 and memory hub 1105 may be integrated into a single chip. It is also possible that two or more sets of processor(s) 1102 are attached via multiple sockets, which can couple with two or more instances of the parallel processor(s) 1112.

Some of the particular components shown herein are optional and may not be included in all implementations of the computing system 1100. For example, any number of add-in cards or peripherals may be supported, or some components may be eliminated. Furthermore, some architectures may use different terminology for components similar to those illustrated in FIG. 11. For example, the memory hub 1105 may be referred to as a Northbridge in some architectures, while the I/O hub 1107 may be referred to as a Southbridge.

### Example Core Architectures—In-Order and Out-of-Order Core Block Diagram

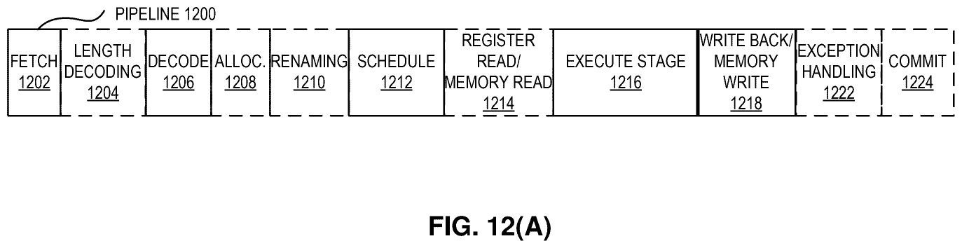

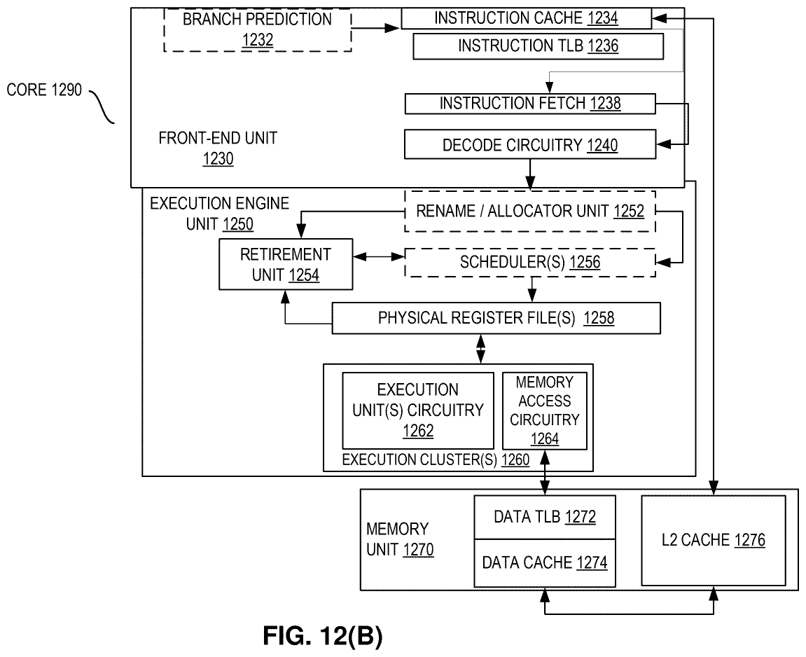

FIG. 12(A) is a block diagram illustrating both an example in-order pipeline and an example register renaming, out-of-order issue/execution pipeline according to examples. FIG. 12(B) is a block diagram illustrating both an example in-order architecture core and an example register renaming, out-of-order issue/execution architecture core to be included in a processor according to examples. The solid lined boxes in FIGS. 12(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12(A), a processor pipeline 1200 includes a fetch stage 1202, an optional length decoding stage 1204, a decode stage 1206, an optional allocation (Alloc) stage 1208, an optional renaming stage 1210, a schedule (also known as a dispatch or issue) stage 1212, an optional register read/memory read stage 1214, an execute stage 1216, a write back/memory write stage 1218, an optional exception handling stage 1222, and an optional commit stage 1224. One or more operations can be performed in each of these processor pipeline stages. For example, during the fetch stage 1202, one or more instructions are fetched from instruction memory, and during the decode stage 1206, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 1206 and the register read/memory read stage 1214 may be combined into one pipeline stage. In some examples, during the execute stage 1216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 12(B) may implement the pipeline 1200 as follows: 1) the instruction fetch circuitry 1238 performs the fetch and length decoding stages 1202 and 1204; 2) the decode circuitry 1240 performs the decode stage 1206; 3) the rename/allocator unit circuitry 1252 performs the allocation stage 1208 and renaming stage 1210; 4) the scheduler(s) circuitry 1256 performs the schedule stage 1212; 5) the physical register file(s) circuitry 1258 and the memory unit circuitry 1270 perform the register read/memory read stage 1214; the execution cluster(s) 1260 perform the execute stage 1216; 6) the memory unit circuitry 1270 and the physical register file(s) circuitry 1258 perform the write back/memory write stage 1218; 7) various circuitry may be involved in the exception handling stage 1222; and 8) the retirement unit circuitry 1254 and the physical register file(s) circuitry 1258 perform the commit stage 1224.

FIG. 12(B) shows a processor core 1290 including front-end unit circuitry 1230 coupled to execution engine unit circuitry 1250, and both are coupled to memory unit circuitry 1270. The core 1290 may be a reduced instruction set architecture computing (RISC) core, a complex instruction set architecture computing (CISC) core, a very long instruction word (VLIW) core, or a hybrid or alternative core type. As yet another option, the core 1290 may be a special-purpose core, such as, for example, a network or communication core, compression engine, co-processor core, general purpose computing graphics processing unit (GPGPU) core, graphics core, or the like.

The front-end unit circuitry 1230 may include branch prediction circuitry 1232 coupled to instruction cache circuitry 1234, which is coupled to an instruction translation lookaside buffer (TLB) 1236, which is coupled to instruction fetch circuitry 1238, which is coupled to decode circuitry 1240. In some examples, the instruction cache circuitry 1234 is included in the memory unit circuitry 1270 rather than the front-end unit circuitry 1230. The decode circuitry 1240 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1240 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 1240 may be implemented using various different mechanisms. Examples of suitable mechanisms include, but are not limited to, look-up tables, hardware implementations, programmable logic arrays (PLAs), microcode read only memories (ROMs), etc. In some examples, the core 1290 includes a microcode ROM (not shown) or other medium that stores microcode for certain macroinstructions (e.g., in decode circuitry 1240 or otherwise within the front-end unit circuitry 1230). In some examples, the decode circuitry 1240 includes a micro-operation (micro-op) or operation cache (not shown) to hold/cache decoded operations, micro-tags, or micro-operations generated during the decode or other stages of the processor pipeline 1200. The decode circuitry 1240 may be coupled to rename/allocator unit circuitry 1252 in the execution engine unit circuitry 1250.

The execution engine unit circuitry 1250 includes the rename/allocator unit circuitry 1252 coupled to retirement unit circuitry 1254 and a set of one or more scheduler(s) circuitry 1256. The scheduler(s) circuitry 1256 represents any number of different schedulers, including reservations stations, central instruction window, etc. In some examples, the scheduler(s) circuitry 1256 can include arithmetic logic unit (ALU) scheduler/scheduling circuitry, ALU queues, address generation unit (AGU) scheduler/scheduling circuitry, AGU queues, etc. The scheduler(s) circuitry 1256 is coupled to the physical register file(s) circuitry 1258. Each of the physical register file(s) circuitry 1258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 1258 includes vector registers unit circuitry, writemask registers unit circuitry, and scalar register unit circuitry. These register units may provide architectural vector registers, vector mask registers, general-purpose registers, etc. The physical register file(s) circuitry 1258 is coupled to the retirement unit circuitry 1254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1254 and the physical register file(s) circuitry 1258 are coupled to the execution cluster(s) 1260. The execution cluster(s) 1260 includes a set of one or more execution unit(s) circuitry 1262 and a set of one or more memory access circuitry 1264. The execution unit(s) circuitry 1262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 1262 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1256, physical register file(s) circuitry 1258, and execution cluster(s) 1260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1264). It should also be understood that where separate pipelines are used, one or more of these pipelines may be out-of-order issue/execution and the rest in-order.

In some examples, the execution engine unit circuitry 1250 may perform load store unit (LSU) address/data pipelining to an Advanced Microcontroller Bus (AMB) interface (not shown), and address phase and writeback, data phase load, store, and branches.

The set of memory access circuitry 1264 is coupled to the memory unit circuitry 1270, which includes data TLB circuitry 1272 coupled to data cache circuitry 1274 coupled to level 2 (L2) cache circuitry 1276. In some examples, the memory access circuitry 1264 may include load unit circuitry, store address unit circuitry, and store data unit circuitry, each of which is coupled to the data TLB circuitry 1272 in the memory unit circuitry 1270. The instruction cache circuitry 1234 is further coupled to the level 2 (L2) cache circuitry 1276 in the memory unit circuitry 1270. In some examples, the instruction cache 1234 and the data cache 1274 are combined into a single instruction and data cache (not shown) in L2 cache circuitry 1276, level 3 (L3) cache circuitry (not shown), and/or main memory. The L2 cache circuitry 1276 is coupled to one or more other levels of cache and eventually to a main memory.

The core 1290 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 1290 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry

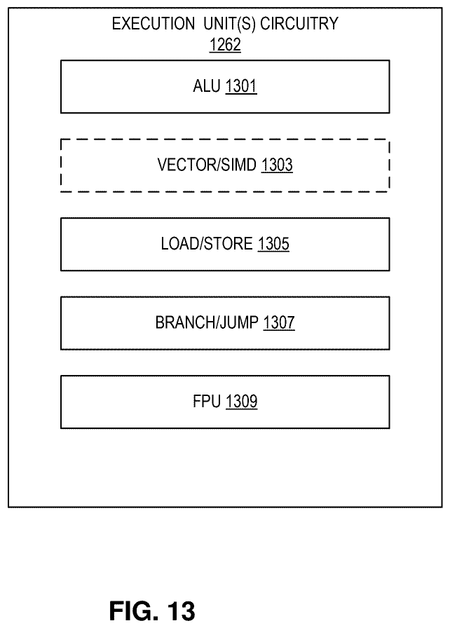

FIG. 13 illustrates examples of execution unit(s) circuitry, such as execution unit(s) circuitry 1262 of FIG. 12(B). As illustrated, execution unit(s) circuitry 1262 may include one or more ALU circuits 1301, optional vector/single instruction multiple data (SIMD) circuits 1303, load/store circuits 1305, branch/jump circuits 1307, and/or Floating-point unit (FPU) circuits 1309. ALU circuits 1301 perform integer arithmetic and/or Boolean operations. Vector/SIMD circuits 1303 perform vector/SIMD operations on packed data (such as SIMD/vector registers). Load/store circuits 1305 execute load and store instructions to load data from memory into registers or store from registers to memory. Load/store circuits 1305 may also generate addresses. Branch/jump circuits 1307 cause a branch or jump to a memory address depending on the instruction. FPU circuits 1309 perform floating-point arithmetic. The width of the execution unit(s) circuitry 1262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

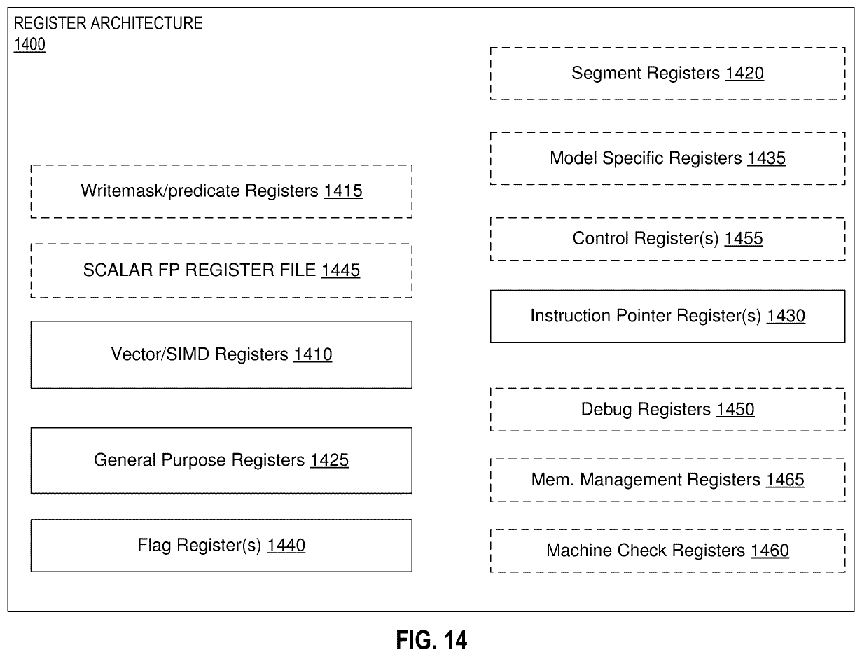

FIG. 14 is a block diagram of a register architecture 1400 according to some examples. As illustrated, the register architecture 1400 includes vector/SIMD registers 1410 that vary from 128-bit to 1,024 bits width. In some examples, the vector/SIMD registers 1410 are physically 512-bits and, depending upon the mapping, only some of the lower bits are used. For example, in some examples, the vector/SIMD registers 1410 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1400 includes writemask/predicate registers 1415. For example, in some examples, there are 8 writemask/predicate registers (sometimes called k0 through k7) that are each 16-bit, 32-bit, 64-bit, or 128-bit in size. Writemask/predicate registers 1415 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1415 corresponds to a data element position of the destination. In other examples, the writemask/predicate registers 1415 are scalable and consists of a set number of enable bits for a given vector element (e.g., 8 enable bits per 64-bit vector element).

The register architecture 1400 includes a plurality of general-purpose registers 1425. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1400 includes scalar floating-point (FP) register file 1445 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1440 (e.g., EFLAGS, RFLAGS, etc.) store status and control information for arithmetic, compare, and system operations. For example, the one or more flag registers 1440 may store condition code information such as carry, parity, auxiliary carry, zero, sign, and overflow. In some examples, the one or more flag registers 1440 are called program status and control registers.

Segment registers 1420 contain segment points for use in accessing memory. In some examples, these registers are referenced by the names CS, DS, SS, ES, FS, and GS.

Model specific registers or machine specific registers (MSRs) 1435 control and report on processor performance. Most MSRs 1435 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1460 consist of control, status, and error reporting MSRs that are used to detect and report on hardware errors. Control register(s) 1455 (e.g., CR0-CR4) determine the operating mode of a processor (e.g., processor 970, 980, 938, 915, and/or 1000) and the characteristics of a currently executing task. In some examples, MSRs 1435 are a subset of control registers 1455.

One or more instruction pointer register(s) 1430 store an instruction pointer value. Debug registers 1450 control and allow for the monitoring of a processor or core's debugging operations.

Memory (mem) management registers 1465 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1400 may, for example, be used in register file/memory 'ISAB08, or physical register file(s) circuitry 12 58.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

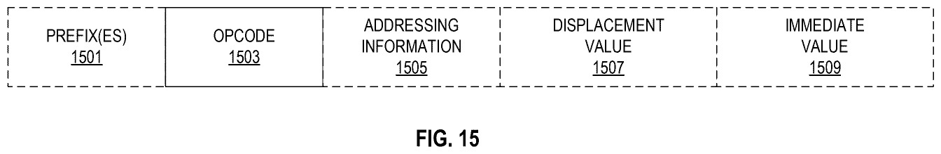

FIG. 15 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1503. In some examples, the order illustrated is the order in which these fields are to be encoded, however, it should be appreciated that in other examples these fields may be encoded in a different order, combined, etc.

The prefix(es) f 1501, when used, modifies an instruction. In some examples, one or more prefixes are used to repeat string instructions (e.g., 0xF0, 0xF 2, 0xF 3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1503 is used to at least partially define the operation to be performed upon a decoding of the instruction. In some examples, a primary opcode encoded in the opcode field 1503 is one, two, or three bytes in length. In other examples, a primary opcode can be a different length. An additional 3-bit opcode field is sometimes encoded in another field.

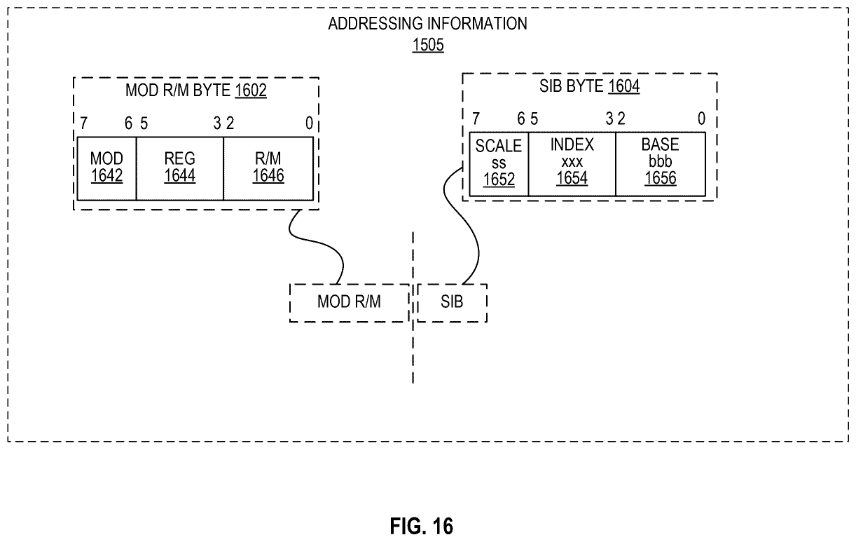

The addressing information field 1505 is used to address one or more operands of the instruction, such as a location in memory or one or more registers. FIG. 16 illustrates examples of the addressing information field 1505. In this illustration, an optional MOD R/M byte 1602 and an optional Scale, Index, Base (SIB) byte 1604 are shown. The MOD R/M byte 1602 and the SIB byte 1604 are used to encode up to two operands of an instruction, each of which is a direct register or effective memory address. Note that both of these fields are optional in that not all instructions include one or more of these fields. The MOD R/M byte 1602 includes a MOD field 1642, a register (reg) field 1644, and R/M field 1646.

The content of the MOD field 1642 distinguishes between memory access and non-memory access modes. In some examples, when the MOD field 1642 has a binary value of 11 (11 b), a register-direct addressing mode is utilized, and otherwise a register-indirect addressing mode is used.

The register field 1644 may encode either the destination register operand or a source register operand or may encode an opcode extension and not be used to encode any instruction operand. The content of register field 1644, directly or through address generation, specifies the locations of a source or destination operand (either in a register or in memory). In some examples, the register field 1644 is supplemented with an additional bit from a prefix (e.g., prefix 1501) to allow for greater addressing.

The R/M field 1646 may be used to encode an instruction operand that references a memory address or may be used to encode either the destination register operand or a source register operand. Note the R/M field 1646 may be combined with the MOD field 1642 to dictate an addressing mode in some examples.

The SIB byte 1604 includes a scale field 1652, an index field 1654, and a base field 1656 to be used in the generation of an address. The scale field 1652 indicates a scaling factor. The index field 1654 specifies an index register to use. In some examples, the index field 1654 is supplemented with an additional bit from a prefix (e.g., prefix 1501) to allow for greater addressing. The base field 1656 specifies a base register to use. In some examples, the base field 1656 is supplemented with an additional bit from a prefix (e.g., prefix 1501) to allow for greater addressing. In practice, the content of the scale field 1652 allows for the scaling of the content of the index field 1654 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1507 provides this value. Additionally, in some examples, a displacement factor usage is encoded in the MOD field of the addressing information field 1505 that indicates a compressed displacement scheme for which a displacement value is calculated and stored in the displacement field 1507.

In some examples, the immediate value field 1509 specifies an immediate value for the instruction. An immediate value may be encoded as a 1-byte value, a 2-byte value, a 4-byte value, etc.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Furthermore, the disclosure describes various examples in detail as noted above. Further examples are noted below:

Example 1. A processor comprising:
a logic circuit to receive a packet for transfer to a peer destination on a packet transfer fabric and evaluate the packet based on a number of criteria related to packet configuration, wherein the logic circuit is to:
   when the packet meets requirements of the number of criteria related to the packet configuration, encode a packet header into an unencapsulated format and place payload data of the packet at a beginning of a payload data section of the packet; and
   when the packet does not meet the requirements, encode the packet header into an encapsulated format and place the encapsulated packet header at the beginning of the payload data section of the packet; and
an interface to receive the packet from the logic circuit, where the packet header is in the encapsulated format or the unencapsulated format, and transmit the packet onto the packet transfer fabric to send the packet to the peer destination.

Example 2. The processor according to Example 1, wherein the packet transfer fabric is an internal fabric having connection lines to accommodate a number of packet header bytes in the unencapsulated format.

Example 3. The processor according to any one of Examples 1-2, wherein the packet transfer fabric implements a peer-to-peer communication standard for communication on the packet transfer fabric.

Example 4. The processor according to any one of Examples 1-3, wherein the peer-to-peer communication standard is Peripheral Component Interconnect express (PCIe) and the packet header is a PCIe packet header.

Example 5. The processor according to any one of Examples 1-4, wherein an entirety of the PCIe packet header is encapsulated and placed at the beginning of the payload data section of the packet.

Example 6. The processor according to any one of Examples 1-5, wherein when the PCIe packet header is placed at the beginning of the payload data section, a PCIe trailer is placed at an end of the payload data section.

Example 7. The processor according to any one of Examples 1-5, wherein packet headers for Memory read, Memory write, Unordered Input/Output (UIO) read and UIO write packets are encoded into the unencapsulated format.

Example 8. The processor according to any one of Examples 1-5, wherein the number of criteria for unencapsulated format comprises requirements that:
Reserved PCIe fields to be 0;
Orthogonal header Content (OHC) to be 0;
Trailer Size (TS) to be 0;
Payload data to be aligned to capability of the packet transfer fabric; and
Address to be aligned to capability of the packet transfer fabric.

Example 9. A method comprising:
receiving a packet for transfer to a peer destination on a packet transfer fabric;
evaluating the packet based on a number of criteria related to packet configuration,
   wherein;
   when the packet meets requirements of the number of criteria related to the packet configuration, encoding a packet header into an unencapsulated format and placing payload data of the packet at a beginning of a payload data section of the packet; and
   when the packet does not meet the requirements, encoding the packet header into an encapsulated format and placing the encapsulated packet header at the beginning of the payload data section of the packet; and
transmitting the packet onto the packet transfer fabric in the unencapsulated format or the encapsulated format to send the packet to the peer destination.

Example 10. The method according to Example 9, wherein the packet transfer fabric is an internal fabric having connection lines to accommodate a number of packet header bytes in the unencapsulated format.

Example 11. The method according to any one of Examples 9-10, wherein the packet transfer fabric implements a Peripheral Component Interconnect express (PCIe) communication standard for peer-to-peer communication on the packet transfer fabric and the packet header is a PCIe packet header.

Example 12. The method according to any one of Examples 9-11, wherein an entirety of the PCIe packet header is encapsulated and placed at the beginning of the payload data section of the packet.

Example 13. The method according to any one of Examples 9-12, wherein when the PCIe packet header is placed at the beginning of the payload data section, a PCIe trailer is placed at an end of the payload data section.

Example 14. The method according to any one of Examples 9-12, wherein packet headers for Memory read, Memory write, Unordered Input/Output (UIO) read and UIO write packets are encoded into the unencapsulated format.

Example 15. The method according to any one of Examples 9-12, wherein the number of criteria for unencapsulated format comprises requirements that:
Reserved PCIe fields to be 0;
Orthogonal header Content (OHC) to be 0;
Trailer Size (TS) to be 0;
Payload data to be aligned to capability of the packet transfer fabric; and
Address to be aligned to capability of the packet transfer fabric.

Example 16. A system comprising:
a packet transfer fabric to transfer packets to a peer destination, wherein some packets are in an unencapsulated format and some packets are in an encapsulated format;
a processor, coupled to the packet transfer fabric, to evaluate a packet based on a number of criteria related to packet configuration for transfer of the packet on the packet transfer fabric, wherein the processor is to:
   when the packet meets requirements of the number of criteria related to the packet configuration, encode a packet header into an unencapsulated format and place payload data of the packet at a beginning of a payload data section of the packet; and
   when the packet does not meet the requirements, encode the packet header into an encapsulated format and place the encapsulated packet header at the beginning of the payload data section of the packet; and
a peer destination, coupled to the packet transfer fabric, to receive the packet from the processor in the encapsulated format or the unencapsulated format.

Example 17. The system according to Example 16, wherein the packet transfer fabric implements a Peripheral Component Interconnect express (PCIe) communication standard for peer-to-peer communication on the packet transfer fabric and the packet is a PCIe packet.

Example 18. The system according to any one of Examples 16-17, wherein the packet header is a PCIe packet header, wherein the PCIe packet header is encapsulated and placed at the beginning of the payload data section of the packet.

Example 19. The system according to any one of Examples 16-18, wherein when the PCIe packet header is placed at the beginning of the payload data section, a PCIe trailer is placed at an end of the payload data section.

Example 20. The system according to any one of Examples 16-18, wherein packet headers for Memory read, Memory write, Unordered Input/Output (UIO) read and UIO write packets are encoded into the unencapsulated format.

What is claimed is:

1. A processor comprising:
a logic circuit to receive a packet for transfer to a peer destination on a packet transfer fabric and evaluate the packet based on a number of criteria related to packet configuration, wherein the logic circuit is to:
when the packet meets requirements of the number of criteria related to the packet configuration, encode a packet header into an unencapsulated format and place payload data of the packet at a beginning of a payload data section of the packet; and
when the packet does not meet the requirements, encode the packet header into an encapsulated format and place the encapsulated packet header at the beginning of the payload data section of the packet; and
an interface to receive the packet from the logic circuit, where the packet header is in the encapsulated format or the unencapsulated format, and transmit the packet onto the packet transfer fabric to send the packet to the peer destination.

2. The processor according to claim 1, wherein the packet transfer fabric is an internal fabric having connection lines to accommodate a number of packet header bytes in the unencapsulated format.

3. The processor according to claim 2, wherein the packet transfer fabric implements a peer-to-peer communication standard for communication on the packet transfer fabric.

4. The processor according to claim 3, wherein the peer-to-peer communication standard is Peripheral Component Interconnect express (PCIe) and the packet header is a PCIe packet header.

5. The processor according to claim 4, wherein an entirety of the PCIe packet header is encapsulated and placed at the beginning of the payload data section of the packet.

6. The processor according to claim 5, wherein when the PCIe packet header is placed at the beginning of the payload data section, a PCIe trailer is placed at an end of the payload data section.

7. The processor according to claim 5, wherein packet headers for Memory read, Memory write, Unordered Input/Output (UIO) read and UIO write packets are encoded into the unencapsulated format.

8. The processor according to claim 5, wherein the number of criteria for unencapsulated format comprises requirements that:
Reserved PCIe fields to be 0;
Orthogonal header Content (OHC) to be 0;
Trailer Size (TS) to be 0;
Payload data to be aligned to capability of the packet transfer fabric; and
Address to be aligned to capability of the packet transfer fabric.

9. A method comprising:
receiving a packet for transfer to a peer destination on a packet transfer fabric;
evaluating the packet based on a number of criteria related to packet configuration, wherein;
when the packet meets requirements of the number of criteria related to the packet configuration, encoding a packet header into an unencapsulated format and placing payload data of the packet at a beginning of a payload data section of the packet; and
when the packet does not meet the requirements, encoding the packet header into an encapsulated format and placing the encapsulated packet header at the beginning of the payload data section of the packet; and
transmitting the packet onto the packet transfer fabric in the unencapsulated format or the encapsulated format to send the packet to the peer destination.

10. The method according to claim 9, wherein the packet transfer fabric is an internal fabric having connection lines to accommodate a number of packet header bytes in the unencapsulated format.

11. The method according to claim 10, wherein the packet transfer fabric implements a Peripheral Component Interconnect express (PCIe) communication standard for peer-to-peer communication on the packet transfer fabric and the packet header is a PCIe packet header.

12. The method according to claim 11, wherein an entirety of the PCIe packet header is encapsulated and placed at the beginning of the payload data section of the packet.

13. The method according to claim 12, wherein when the PCIe packet header is placed at the beginning of the payload data section, a PCIe trailer is placed at an end of the payload data section.

14. The method according to claim 12, wherein packet headers for Memory read, Memory write, Unordered Input/Output (UIO) read and UIO write packets are encoded into the unencapsulated format.

15. The method according to claim 12, wherein the number of criteria for unencapsulated format comprises requirements that:
Reserved PCIe fields to be 0;
Orthogonal header Content (OHC) to be 0;
Trailer Size (TS) to be 0;
Payload data to be aligned to capability of the packet transfer fabric; and
Address to be aligned to capability of the packet transfer fabric.

16. A system comprising:
a packet transfer fabric to transfer packets to a peer destination, wherein some packets are in an unencapsulated format and some packets are in an encapsulated format;
a processor, coupled to the packet transfer fabric, to evaluate a packet based on a number of criteria related to packet configuration for transfer of the packet on the packet transfer fabric, wherein the processor is to:
when the packet meets requirements of the number of criteria related to the packet configuration, encode a packet header into an unencapsulated format and place payload data of the packet at a beginning of a payload data section of the packet; and
when the packet does not meet the requirements, encode the packet header into an encapsulated format and place the encapsulated packet header at the beginning of the payload data section of the packet; and
a peer destination, coupled to the packet transfer fabric, to receive the packet from the processor in the encapsulated format or the unencapsulated format.

17. The system according to claim 16, wherein the packet transfer fabric implements a Peripheral Component Interconnect express (PCIe) communication standard for peer-to-peer communication on the packet transfer fabric and the packet is a PCIe packet.

18. The system according to claim 17, wherein the packet header is a PCIe packet header, wherein the PCIe packet header is encapsulated and placed at the beginning of the payload data section of the packet.

19. The system according to claim 18, wherein when the PCIe packet header is placed at the beginning of the payload data section, a PCIe trailer is placed at an end of the payload data section.

20. The system according to claim 18, wherein packet headers for Memory read, Memory write, Unordered Input/Output (UIO) read and UIO write packets are encoded into the unencapsulated format.
